(19) United States
(12) Patent Application Publication
(10) Pub. No.: US 2025/0258631 A1
(43) Pub. Date: Aug. 14, 2025

(54) INSPECTION SYSTEM, INSPECTION APPARATUS, INSPECTION METHOD, AND NON-TRANSITORY RECORDING MEDIUM

(71) Applicants: Hirooki Toyama, KANAGAWA (JP); Takashi Sakamaki, KANAGAWA (JP)

(72) Inventors: Hirooki Toyama, KANAGAWA (JP); Takashi Sakamaki, KANAGAWA (JP)

(73) Assignee: Ricoh Company, Ltd., Tokyo (JP)

(21) Appl. No.: 19/039,224

(22) Filed: Jan. 28, 2025

(30) Foreign Application Priority Data
Feb. 9, 2024 (JP) 2024-018924

(51) Int. Cl. G06F 3/12; G06T 7/00

(52) U.S. Cl. CPC G06F 3/121; G06F 3/1234; G06T 7/001; G06T 2207/30144

(57) ABSTRACT

An inspection apparatus includes circuitry. The circuitry generates printing data from design data including a variable area and record information of variable input data. The circuitry inspects whether data read from the variable area of the printing data includes an error, based on the record information of the variable input data. The circuitry controls printing of the printing data in accordance with a result of inspecting the error.

### CROSS-REFERENCE TO RELATED APPLICATIONS

This patent application is based on and claims priority pursuant to 35 U.S.C. § 119 (a) to Japanese Patent Application No. 2024-018924, filed on Feb. 9, 2024, in the Japan Patent Office, the entire disclosure of which is hereby incorporated by reference herein.

### BACKGROUND

### Technical Field

The present disclosure relates to an inspection system, an inspection apparatus, an inspection method, and a non-transitory recording medium.

### Related Art

Variable printing prints different contents on a part of a printed material such as the postal code and address of a destination, according to the contents of records of input data. Further, a print inspection apparatus reads a printed material on which a printing apparatus has performed variable printing, and compares the read printed material with each record of original input data to inspect whether printing is normally performed.

### SUMMARY

According to an embodiment of the present disclosure, an inspection apparatus includes circuitry. The circuitry generates printing data from design data including a variable area and record information of variable input data. The circuitry inspects whether data read from the variable area of the printing data includes an error, based on the record information of the variable input data. The circuitry controls printing of the printing data in accordance with a result of inspecting the error.

According to an embodiment of the present disclosure, an inspection method performed by one or more computers includes generating printing data from design data including a variable area and record information of variable input data. The inspection method includes whether data read from the variable area of the printing data includes an error, based on the record information of the variable input data. The inspection method includes controlling printing of the printing data in accordance with a result of the inspecting the error.

According to an embodiment of the present disclosure, a non-transitory recording medium storing a plurality of instructions which, when executed by one or more processors, causes the one or more processors to perform an inspection method. The inspection method includes generating printing data from design data including a variable area and record information of variable input data. The inspection method includes whether data read from the variable area of the printing data includes an error, based on the record information of the variable input data. The inspection method includes controlling printing of the printing data in accordance with a result of the inspecting the error.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of an inspection system;

FIG. 2 is a diagram illustrating an overview of processing according to an embodiment;

FIG. 3 is a block diagram illustrating an example of a hardware configuration of a computer;

FIG. 4 is a diagram illustrating an example of a functional configuration of an inspection system;

FIG. 5 is a flowchart illustrating an example of processing performed by an inspection system according to a first embodiment;

FIG. 6A is a diagram illustrating an example of a UI screen, and FIG. 6B is a diagram illustrating another example of a UI screen;

FIG. 7 is a diagram illustrating an example of a UI screen;

FIG. 8 is a diagram illustrating an example of variable input data;

FIG. 9 is a diagram illustrating an example of a UI screen;

FIG. 10 is a flowchart illustrating an example of first inspection processing according to the first embodiment;

FIG. 11 is a diagram illustrating an example of an inspection result of first inspection processing according to the first embodiment;

FIG. 12 is a diagram illustrating an example of a display screen of an inspection result according to the first embodiment;

FIG. 13 is a flowchart illustrating an example of second inspection processing according to the first embodiment;

FIG. 14 is a diagram illustrating an example of a display screen of an inspection result according to the first embodiment;

FIG. 15 is a flowchart illustrating an example of processing performed by an inspection system according to a second embodiment;

FIG. 16 is a diagram for illustrating an overview of processing according to a third embodiment;

FIG. 17A is a diagram illustrating an example of data according to the third embodiment, and FIG. 17B is a diagram illustrating an example of data according to the third embodiment; and

FIG. 18 is a flowchart illustrating an example of first inspection processing according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to drawings.

### System Configuration

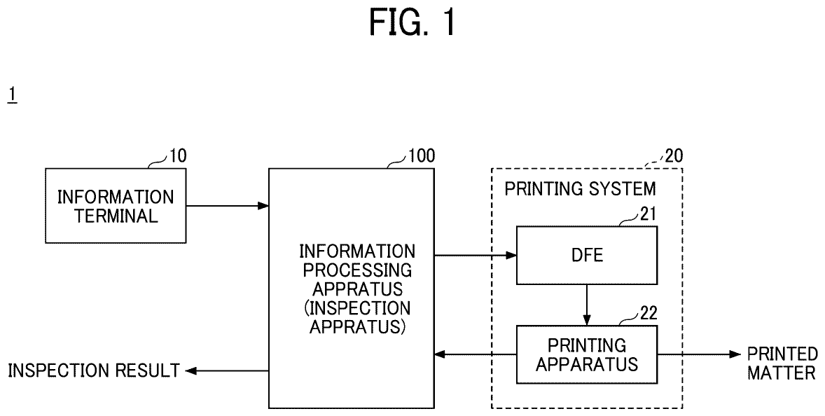

FIG. 1 is a diagram illustrating an example of a system configuration of an inspection system. The inspection system 1 is a system that inspects printing data used for variable printing, which prints different contents on a part of a printed material such as the postal code and address of a destination, according to contents of each record of input data, and the printed material. As illustrated in FIG. 1, the inspection system 1 includes an information terminal 10, an information processing apparatus (inspection apparatus) 100, a digital front end (DFE) 21, and a printing apparatus 22. The DFE 21 and the printing apparatus 22 are examples of a printing system 20 that prints printing data.

The information terminal 10 is a computer connected to the information processing apparatus 100 to communicate with the information processing apparatus 100. As an example, the information terminal 10 is a personal computer (PC) used by a client who orders the variable printing. In this case, the information terminal 10 transmits submission data used for performing the variable printing to the information processing apparatus 100. The inspection system 1 may acquire the submission data from a server apparatus that manages submission data used for performing the variable printing, instead of the information terminal 10. In this case, the information processing apparatus 100 acquires the submission data used for performing the variable printing from the server apparatus as needed.

The submission data used for performing the variable printing includes, for example, design data and variable input data. The design data is data used for printing a common portion of the variable printing. Examples of the design data include, but not limited to, image data such as portable document format (PDF) data. The variable input data is data used for printing a variable portion of the variable printing. Examples of the variable input data include, but not limited to, text data such as comma separated values (CSV) data.

The information processing apparatus (inspection apparatus) 100 is, for example, a computer connected to the information terminal 10 and the printing system 20 to communicate with the information terminal 10 and the printing system 20. The information processing apparatus 100 generates printing data (e.g., PDF data) used for the variable printing based on the submission data acquired from the information terminal 10, and performs, for example, inspection of the printing data, control of printing, and inspection of the printed material.

The DFE 21 is an information processing apparatus that performs raster image processor (RIP) processing to convert the printing data generated by the information processing apparatus 100 into a raster image printable by the printing apparatus 22. The printing apparatus 22 or the information processing apparatus 100 may have the function of the DFE 21.

The printing apparatus 22 is an image forming apparatus that performs printing on a sheet of paper as a recording medium based on the data generated by the DFE 21. The printing apparatus 22 according to the present embodiment has a function of acquiring read image data obtained by reading a printed material printed by the printing apparatus 22. Further, the printing apparatus 22 may be connected to a post-processing apparatus such as a stacker that stacks the printed material printed by the printing apparatus 22 on a tray.

### Overview of Operation

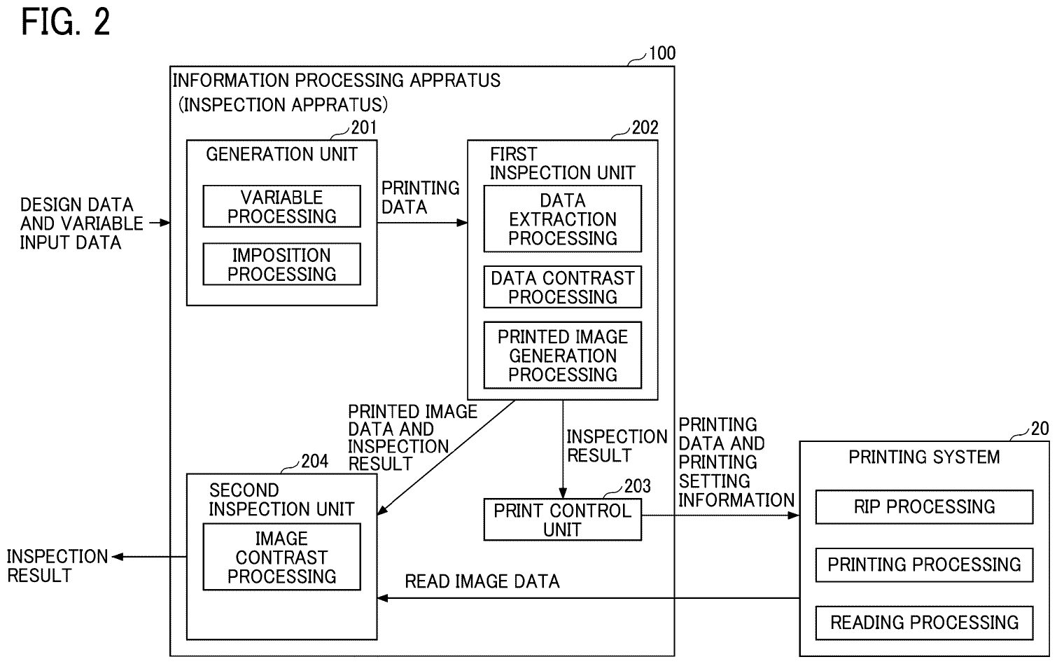

FIG. 2 is a diagram illustrating an overview of processing according to an embodiment. The information processing apparatus 100 includes a generation unit 201 that generates printing data (e.g., a PDF file) from, for example, input design data (e.g., a PDF file) having a variable area and record information of variable input data (a CSV file).

An operator performs, for example, design of a printed material, imposition, setting of a variable area, and print setting using a predetermined application program installed in the information processing apparatus 100. In response to this, the generation unit 201 performs, for example, variable processing and imposition processing, and generates printing data for the variable printing.

The information processing apparatus 100 further includes a first inspection unit 202 that inspects the presence of an error in data read from the variable area of the printing data generated by the generation unit 201 based on the record information of the variable input data. The first inspection unit 202 performs, for example, data extraction processing of extracting the record information from the variable area of the printing data, and data comparison processing of comparing the record information of the variable input data with the extracted record information to inspect the presence of an error in the variable area of the printing data. In addition, when there is no error in the variable area of the printing data, the first inspection unit 202 performs print-image generation processing of generating print image data (master data) obtained by imaging the printing data.

The information processing apparatus 100 further includes a print control unit 203 that controls printing of the printing data in accordance with the result of the inspection performed by the first inspection unit 202. For example, when the data read from the variable area of the printing data includes no error, the print control unit 203 transmits, for example, the printing data and print-setting information to the printing system 20 and controls the printing system 20 to start printing the printing data. On the other hand, when the data read from the variable area of the printing data includes an error, the print control unit 203 controls the printing system 20 to cancel printing the printing data. For example, when the data read from the variable area of the printing data includes an error, the print control unit 203 does not transmit, for example, the printing data and the print-setting information to the printing system 20.

The printing system 20 performs the RIP processing and printing processing on the printing data based on the printing data and the print-setting information received from the information processing apparatus 100, to generate a printed material. Additionally, the printing system 20 performs reading processing on the printed material and transmits the read image data to the information processing apparatus 100.

The information processing apparatus 100 further includes a second inspection unit 204 that inspects a defect of a printed material by performing image comparison processing of comparing the print image data generated by the first inspection unit 202 with the acquired read image data.

By the above-described configuration, the inspection system 1 does not transmit the printing data and the print-setting information to the printing system 20 when the printing data of the variable printing includes an error, and thus prevents an unnecessary printed material from being generated. In addition, the inspection system 1 performs each inspection at an appropriate timing in a process of inspection processing of consistently performing the inspection from the printing data to the printed material.

### Hardware Configuration

### Hardware Configuration of Information Processing Apparatus

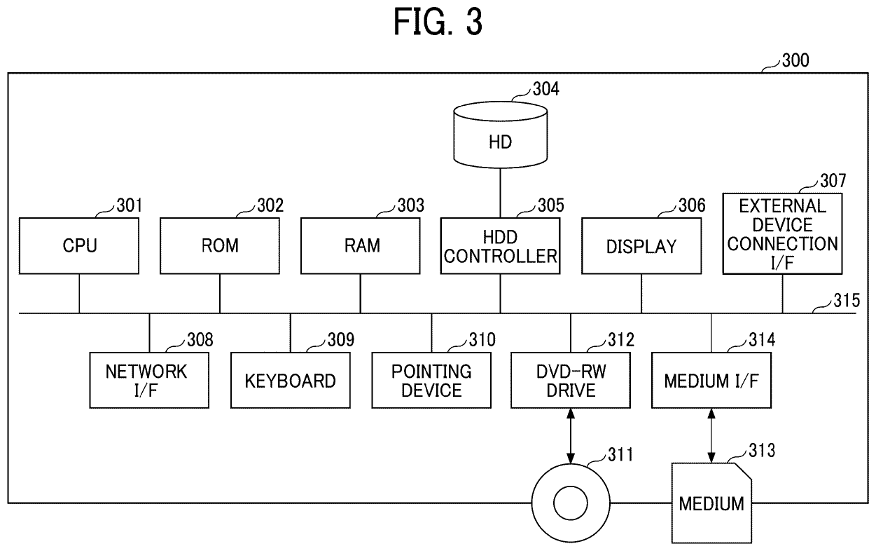

For example, the information processing apparatus 100 has a hardware configuration of a computer 300 as illustrated in FIG. 3. Alternatively, the information processing apparatus 100 is implemented by a plurality of computers 300. For example, the information terminals 10 and the DFE 21 also have the hardware configuration of the computer 300 as illustrated in FIG. 3.

FIG. 3 is a block diagram illustrating an example of the hardware configuration of the computer 300. The computer 300 includes, for example, a central processing unit (CPU) 301, a read-only memory (ROM) 302, a random-access memory (RAM) 303, a hard disk (HD) 304, a hard disk drive (HDD) controller 305, a display 306, an external device connection interface (I/F) 307, a network I/F 308, a keyboard 309, a pointing device 310, a digital versatile disc rewritable (DVD-RW) drive 312, a media I/F 314, and a bus line 315, as illustrated in FIG. 3.

Among these, the CPU 301 controls the entire operation of the computer 300. The ROM 302 stores a program used for starting the computer 300, such as an initial program loader (IPL). The RAM 303 is used as, for example, a work area for the CPU 301. For example, the HD 304 stores programs such as an operating system (OS), an application program, and a device driver and various data. For example, the HDD controller 305 controls reading or writing various data from or to the CPU 301 in accordance with the control of the HD 304. The HD 304 and the HDD controller 305 are examples of storage devices included in the computer 300.

The display 306 displays various information such as a cursor, a menu, a window, a character, and an image. The display 306 may be disposed external to the computer 300. The external device connection I/F 307 is an interface for connecting various external devices to the computer 300. The network I/F 308 is an interface for connecting the computer 300 to a communication network N to communicate with other devices.

The keyboard 309 is an example of an input device having a plurality of keys that allow a user to input characters, numerals, or various instructions. The pointing device 310 is an example of the input device that allows a user to select or perform various instructions, select a target for processing, or move the cursor being displayed. The keyboard 309 and the pointing device 310 may be disposed external to the computer 300.

The DVD-RW drive 312 controls reading and writing various data from and to a DVD-RW 311, which is an example of a removable storage medium. The removable storage medium is not limited to a DVD-RW such as the DVD-RW 311, and may be any other type of removable recording media. The media I/F 314 controls reading or writing (storing) various data from or to a medium 313 such as a flash memory. The bus line 315 includes an address bus and a data bus. The bus line 315 electrically connects the above-described components to each other and transmits, for example, various control signals.

The printing system 20 may have any hardware configuration as long as the printing system 20 has a printing function that prints printing data, a reading function that reads a printed material on which the printing data is printed, and a communication function.

### Functional Configuration

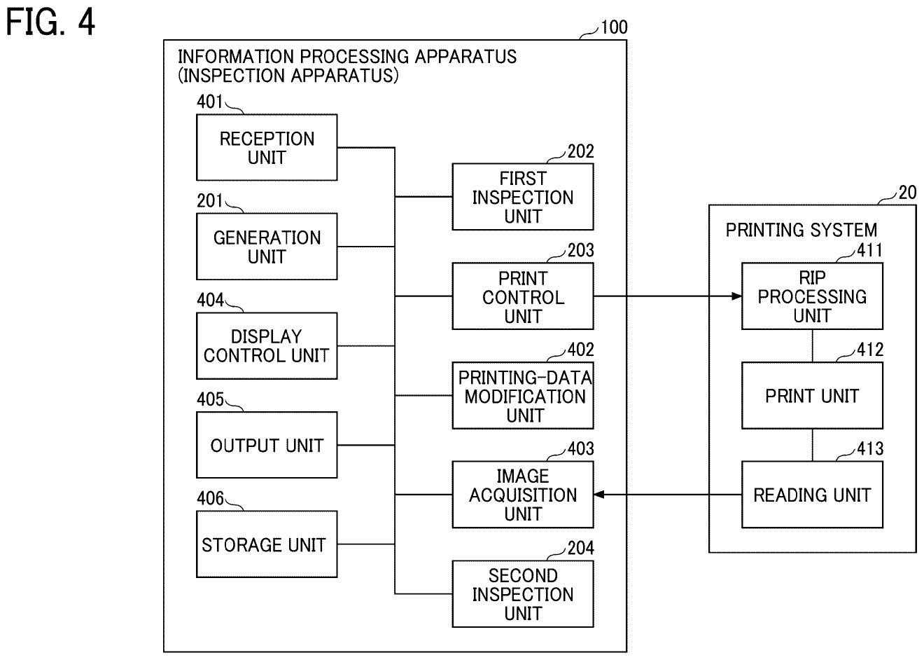

FIG. 4 is a diagram illustrating an example of a functional configuration of the inspection system 1.

### Functional Configuration of Information Processing Apparatus

The information processing apparatus (inspection apparatus) 100 performs a predetermined program in the CPU 301 to implement, for example, each functional configuration as illustrated in FIG. 4. As illustrated in FIG. 3, the information processing apparatus 100 implements each functional configuration of, for example, a reception unit 401, a printing-data modification unit 402, an image acquisition unit 403, a display control unit 404, an output unit 405, and a storage unit 406, in addition to the generation unit 201, the first inspection unit 202, the print control unit 203, and the second inspection unit 204 described with reference to FIG. 2. At least a part of each functional configuration may be implemented by hardware.

The reception unit 401 performs receiving processing of receiving, for example, input of design data (e.g., a PDF file) including a variable area and variable input data (a CSV file), and a setting operation by an operator on a user interface (UI) screen to be described later. For example, the reception unit 401 receives a setting operation such as setting of the design data and the variable input data, imposition setting, setting of the variable area, and print setting.

The generation unit 201 performs generation processing of generating printing data from the input design data and the record information of the variable input data, as illustrated with reference to FIG. 2. For example, the generation unit 201 generates the printing data for generating the printed material including the variable area based on, for example, the setting of the design data and the variable input data, the imposition setting, the setting of the variable area, and the print setting received by the reception unit 401.

The first inspection unit 202 performs first inspection processing of inspecting the presence of an error in data read from the variable area of the printing data generated by the generation unit 201, based on the record information of the variable input data, as illustrated with reference to FIG. 2. For example, the first inspection unit 202 extracts the record information from the variable area of the printing data, compares the record information of the variable input data with the extracted record information, and inspects the presence of the error in the variable area of the printing data. When there is no error in the variable area of the printing data, the first inspection unit 202 generates the print image data (master data) obtained by imaging the printing data.

As illustrated with reference to FIG. 2, the print control unit 203 performs printing control processing of controlling printing of the printing data in accordance with the inspection result obtained from the first inspection unit 202. For example, when there is no error in the data read from the variable area of the printing data, the print control unit 203 transmits, for example, the printing data and the print-setting information to the printing system 20 and controls the printing system 20 to start printing the printing data. On the other hand, when there is an error in the data read from the variable area of the printing data, the print control unit 203 controls the printing system 20 to cancel printing the printing data instead of transmitting, for example, the printing data and the print-setting information to the printing system 20.

As an option, when there is an error in the data read from the variable area of the printing data, the print control unit 203 may modify the portion of the error in the variable area of the printing data, and may control the printing system 20 to start printing the modified printing data.

For example, the printing-data modification unit 402 performs printing-data modifying processing of modifying the portion of the error in the variable area of the printing data in accordance with the control of the print control unit 203. For example, the printing-data modification unit 402 modifies the portion of the error in the variable area of the printing data to a non-printing area so that erroneous information is not printed. The function of the printing-data modification unit 402 may be included in the print control unit 203.

The image acquisition unit 403 performs read-image acquisition processing of acquiring read image data acquired by reading a printed material printed by the printing system 20. For example, the image acquisition unit 403 receives read image data transmitted by the printing system 20 after the print control unit 203 instructs the printing system 20 to perform printing. The function of the image acquisition unit 403 may be included in the second inspection unit 204.

As illustrated with reference to FIG. 2, the second inspection unit 204 inspects a defect in the printed material by comparing the print image data (master data) generated by the first inspection unit 202 with the read image data acquired by the image acquisition unit 403. For example, the second inspection unit 204 performs comparison processing between the read image data and the print image data by image matching processing, and determines that the read image data includes a defect when a matching rate calculated by matching processing is equal to or less than a predetermined value.

The display control unit 404 performs display control processing of controlling display of various display screens. For example, the display control unit 404 performs display control processing of displaying various UI screens to be described later on a display unit such as the display 306.

The output unit 405 performs output processing of outputting a processing result such as an inspection result or a printing result output by the information processing apparatus 100. An output destination of the output result may be, for example, the information terminal 10, the display unit such as the display 306 included in the information processing apparatus 100, or an external server that communicates via the communication network N.

The storage unit 406 stores, for example, various information, data, or programs including the design data, the variable input data, setting information, the inspection result received by the reception unit 401.

The functional configuration of the information processing apparatus 100 illustrated with reference to FIG. 4 is an example. For example, a part or all of the functional units of the functional configuration of the information processing apparatus 100 illustrated in FIG. 4 may be included in the DFE 21 or the printing apparatus 22 of the printing system 20. The functional units of the functional configuration of the information processing apparatus 100 may be distributed among a plurality of apparatuses. In other words, in the inspection system 1, each of the functional units of the functional configuration of the information processing apparatus 100 illustrated in FIG. 4 is included in any one of the apparatuses in the inspection system 1.

### Flow of Processing

A flow of processing of an inspection method will be described.

### Processing by Inspection System

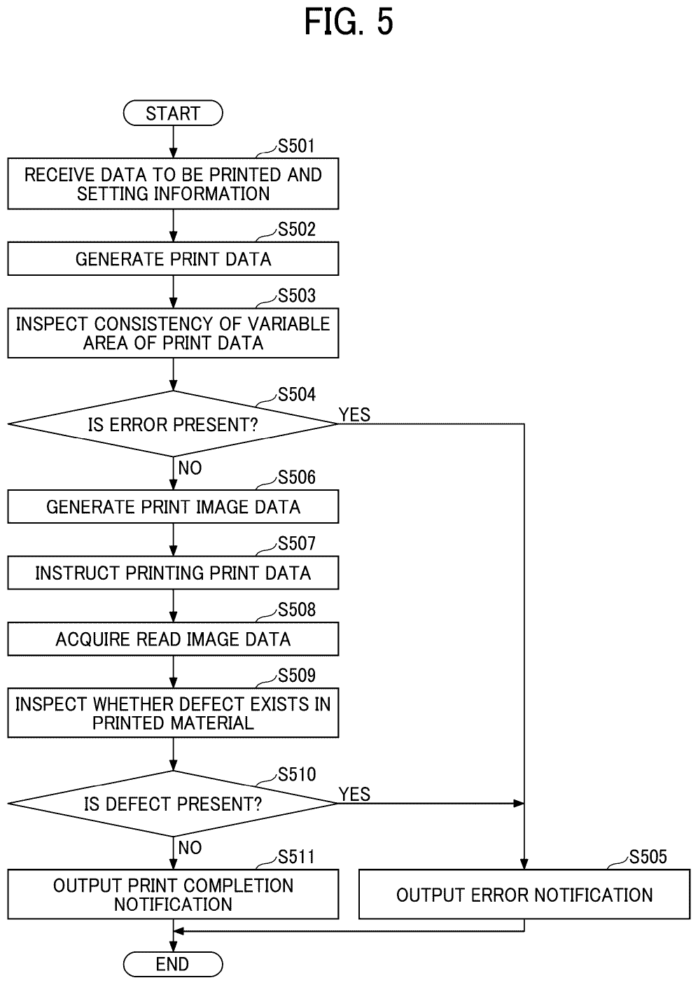

FIG. 5 is a flowchart illustrating an example of processing performed by the inspection system 1 according to a first embodiment.

For example, the processing is an example of print inspection processing performed by the information processing apparatus (inspection apparatus) 100 having the functional configuration described with reference to FIG. 4.

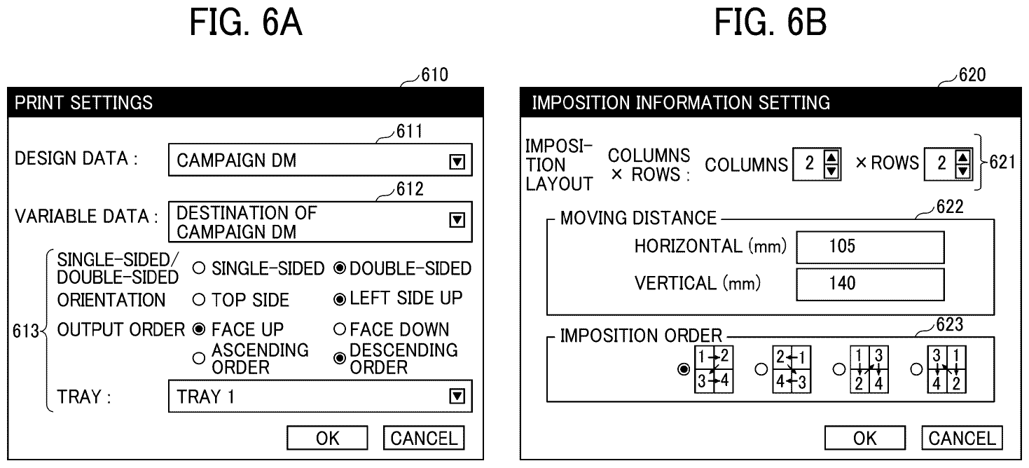

In step S501, the reception unit 401 of the information processing apparatus 100 receives, for example, the printing target data to be printed and inspected and the setting information. For example, the reception unit 401 displays a print-setting screen 610 as illustrated in FIG. 6A using the display control unit 404, and accepts, for example, designation of design data 611, designation of variable input data 612, and print setting 613 input by the operator. The print-setting information may be included in the submitted data.

The reception unit 401 displays, for example, an imposition information setting screen 620 as illustrated in FIG. 6B using the display control unit 404, and accepts, for example, settings of the number of impositions 621, a moving distance 622, or an imposition order 623. The moving distance 622 is a distance in a horizontal direction and a distance in a vertical direction between a plurality of imposed printed materials. FIG. 6A is a diagram illustrating an example of a UI screen. FIG. 6B is a diagram illustrating another example of a UI screen.

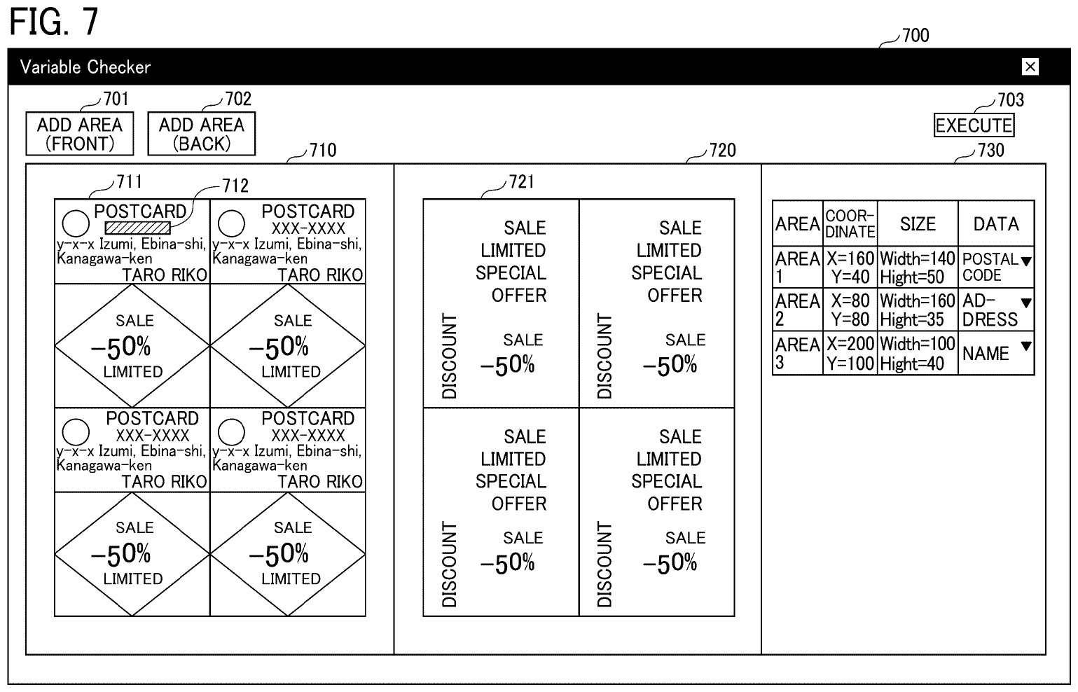

When these settings are executed, the reception unit 401 uses the display control unit 404 to display “Do you want to print the PDF on both sides?,” for example, and accepts selection of “Yes” or “No” input by the operator. In response to this, the reception unit 401 displays, for example, a UI screen 700 as illustrated in FIG. 7, using the display control unit 404, and accepts setting of the variable area.

FIG. 7 is a diagram illustrating an example of a UI screen. As illustrated in FIG. 7, on the UI screen 700, for example, a preview image 710 of the front side of the printing data, a preview image 720 of the back side of the printing data, and an area-data association table 730 are displayed. Further, on the UI screen 700, for example, an “add area (front)” button 701, an “add area (back)” button 702, and an “execute” button 703 are displayed. When printing is to be performed on a single side, the preview image 720 of the back side and the “add area (back)” button 702 are not displayed on the UI screen 700.

As illustrated in FIG. 7, in the preview image 710 of the front side, four imposed printed-material images (front sides) 711 of a printed material are displayed. Similarly, in the preview image 720 of the back side, four imposed printed-material images (back sides) 721 are displayed.

For example, when an operator selects an “add area (front)” button 701 on the UI screen 700, a variable area can be set in the preview image 710 of the front side. For example, the operator performs, for example, a drag operation or a drag-and-drop operation from the upper left coordinates to the lower right coordinates in the preview image 710 on the front side to designate the variable area 712. When the variable area 712 is set by the operator, the reception unit 401 adds information of the set variable area to the area-data association table 730 of the UI screen 700.

As illustrated in FIG. 7, the area-data association table 730 includes information such as “area,” “coordinates,” “size,” and “data” as items. The “area” is information such as an area name or an area ID for identifying the variable area. The “coordinates” and the “size” are information indicating the coordinates and the size of the variable area set by the operator. The “data” is information indicating data corresponding to each variable area, and for example, the data are selected by, for example, a pull-down menu. When a plurality of variable areas is displayed, an operator may add the plurality of variable areas to the area-data association table 730 by similar processing. Accordingly, the reception unit 401 associates the set variable area with the variable input data.

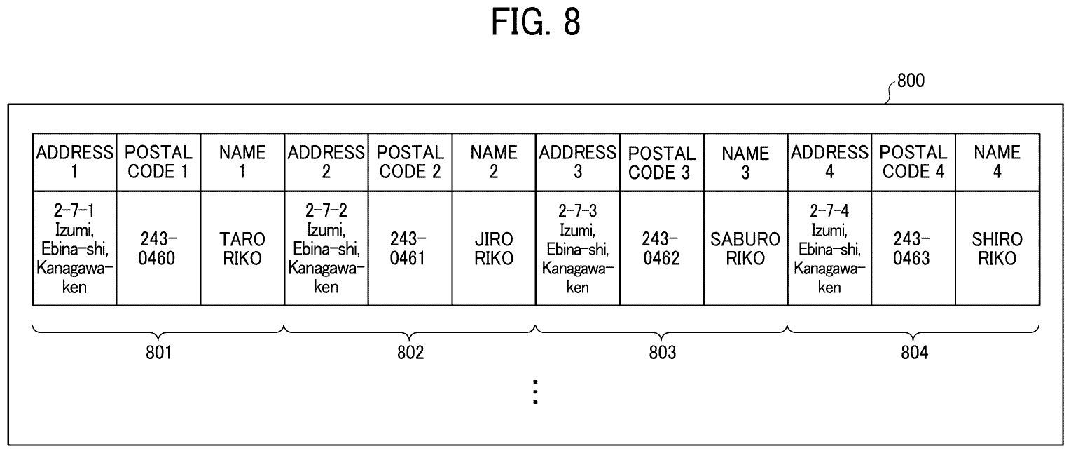

FIG. 8 is a diagram illustrating an example of the variable input data. As illustrated in FIG. 8, the variable input data 800 includes four records 801, 802, 803, and 804 in one row. Each record includes three pieces of record information, that is, an address, a postal code (zip code), and a name. In this case, the variable area and the variable input data may be also associated with each other for another imposed printed-material image (front side) 711 in the same way. For example, the area 1 of the second printed-material image (front side) 711 is associated with “postal code 2” of the variable input data 800. Similarly, the area 1 of the third printed-material image (front side) 711 is associated with “postal code 3” of the variable input data 800.

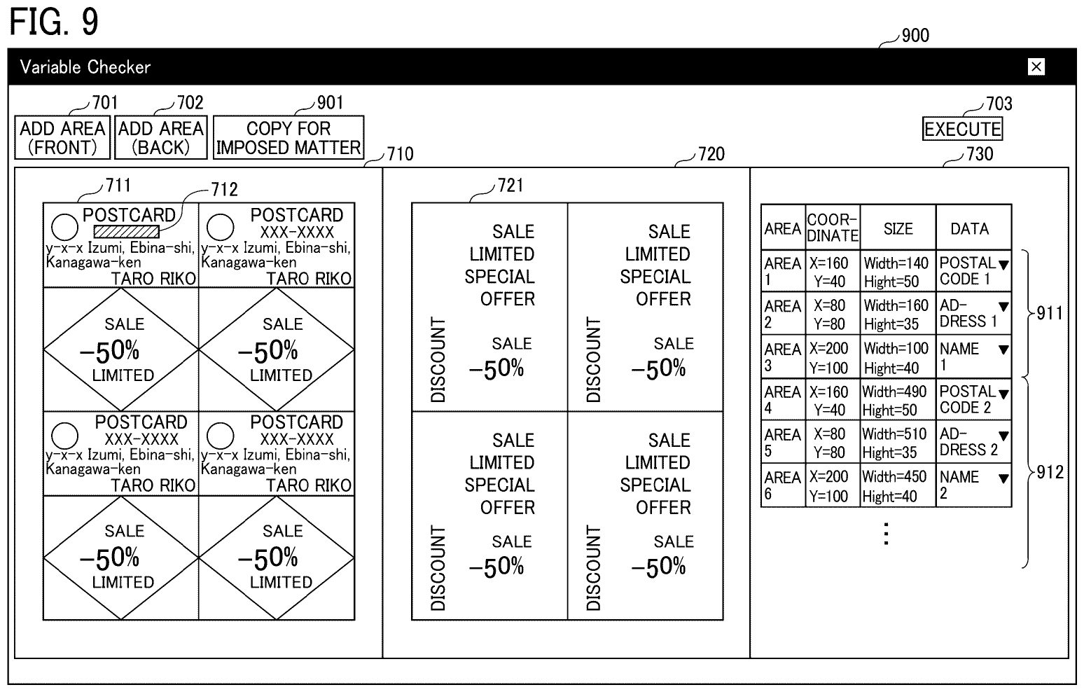

The format of the variable input data 800 illustrated in FIG. 8 is not required. For example, the variable input data may be data in which a record including three pieces of record information of an address, a postal code (postal code number), and a name is stored in each row. In this case, for example, the display control unit 404 displays an area-data association table 910 in which “data” are set for each imposed printed-material image (front side) 711 as in a UI screen 900 illustrated in FIG. 9.

As illustrated in FIG. 9, the UI screen 900 may further display a “Copy for imposed matter” button 901. When the “Copy for imposed matter” button 901 is selected, the reception unit 401 reflects the setting of the variable area set for one printed-material image (front side) 711 on the other printed-material images. For example, the reception unit 401 calculates a relative coordinate position based on the setting of the variable area set for one printed-material image (front side) 711. Additionally, based on the calculation result of the relative coordinate position, the reception unit 401 calculates a relative coordinate position with respect to another imposed printed-material image based on the setting information 911 of the variable area set for the one printed-material image (front side) 711. Additionally, the reception unit 401 automatically sets the setting information 912 of the variable area of the other printed-material image based on the calculation result of the relative coordinate position.

An operator may cause the information processing apparatus 100 to execute the print processing and the inspection processing by selecting the “execute” button 703 illustrated in FIG. 7 or FIG. 9.

Returning to FIG. 5, the description of the flowchart illustrated in FIG. 5 is continued. In step S502, the generation unit 201 of the information processing apparatus 100 generates printing data from design data including a variable area and record information of variable input data, for example, based on a setting operation by an operator.

In step S503, the first inspection unit 202 of the information processing apparatus 100 performs the first inspection processing of inspecting the consistency of the variable area of the printing data generated by the generation unit 201.

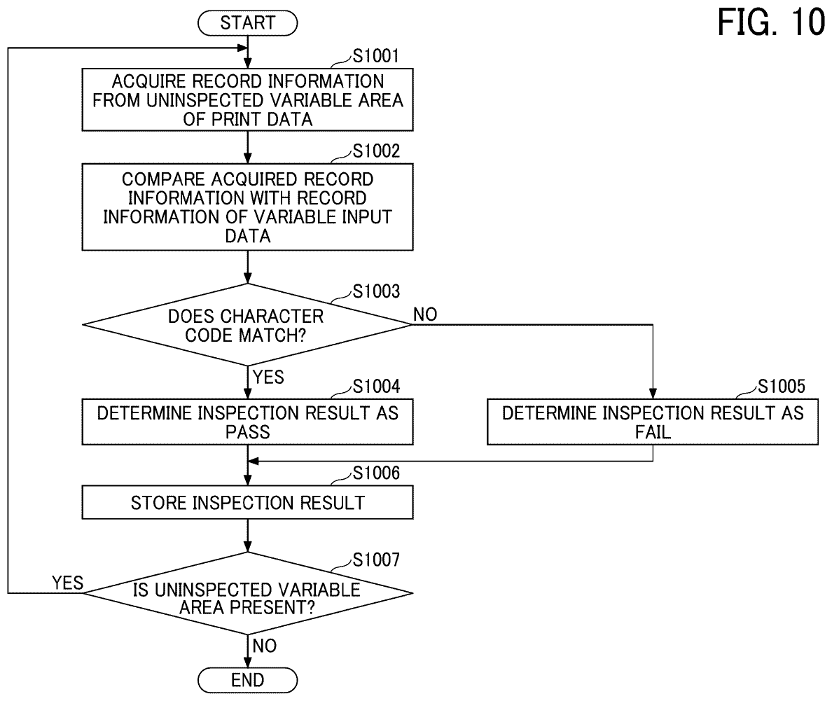

FIG. 10 is a flowchart illustrating an example of the first inspection processing according to the first embodiment. For example, this processing is an example of the first inspection processing in which the first inspection unit 202 inspects the consistency of the variable area of the printing data in step S503 illustrated in FIG. 5.

In step S1001, the first inspection unit 202 acquires record information from an uninspected variable area of the printing data.

In step S1002, the first inspection unit 202 compares the acquired record information with the record information of variable input data. For example, as illustrated in FIG. 9, it is assumed that the data corresponding to the variable area “area 1” is set to “postal code 1” in the area-data association table 910. In this case, the first inspection unit 202 compares the record information acquired from the variable area “area 1” with the record information acquired from “postal code 1” of the variable input data 800.

For example, in step S1003, the first inspection unit 202 compares the record information acquired from the variable area with the record information of the variable input image, and determines whether the character codes match. When the character codes match, the first inspection unit 202 moves the processing to step S1004. On the other hand, when the character codes do not match, the first inspection unit 202 moves the processing to step S1005.

When the processing proceeds to step S1004, the first inspection unit 202 determines that the inspection result of the variable area is “PASS” (there is no problem). On the other hand, when the processing proceeds to step S1005, the first inspection unit 202 determines that the inspection result of the variable area is “FAIL” (there is a problem). In step S1006, the first inspection unit 202 stores the inspection result of the variable area in, for example, the storage unit 406.

In step S1007, the first inspection unit 202 determines whether an uninspected variable area is present. When an uninspected variable area is present, the first inspection unit 202 performs the processing in step S1001 and subsequent steps again. On the other hand, when no uninspected variable area is present, the first inspection unit 202 ends the processing illustrated in FIG. 10.

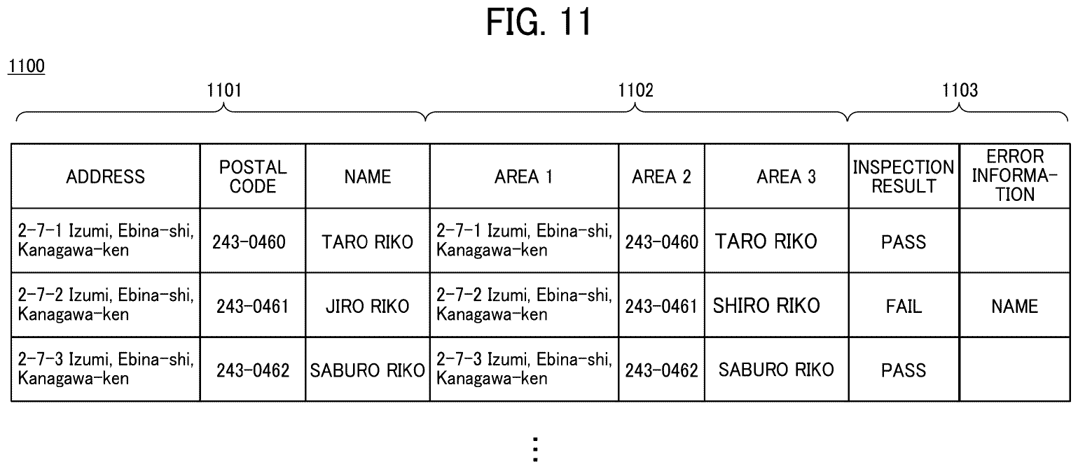

By the processing illustrated in FIG. 10, for example, the first inspection unit 202 creates an inspection result 1100 as illustrated in FIG. 11.

FIG. 11 is a diagram illustrating an example of the inspection result of the first inspection processing according to the first embodiment. As illustrated in FIG. 11, the inspection result 1100 includes record information (an address, a postal code, and a name) 1101 acquired from the variable input data, record information (area 1, area 2, and area 3) 1102 acquired from the variable area, and an inspection result 1103. As illustrated in FIG. 11, the inspection result 1100 includes “error information” for specifying record information of which the inspection result is “FAIL” in addition to the inspection result (PASS or FAIL).

Returning to FIG. 5, the description of the flowchart of FIG. 5 is continued. In step S504, the first inspection unit 202 determines whether there is an error in the variable area of the printing data, for example, from the inspection result 1100 of the first inspection processing as illustrated in FIG. 11. When there is an error in the variable area of the printing data, the first inspection unit 202 moves the processing to step S505. On the other hand, when there is no error in the variable area of the printing data, the first inspection unit 202 moves the processing to step S506.

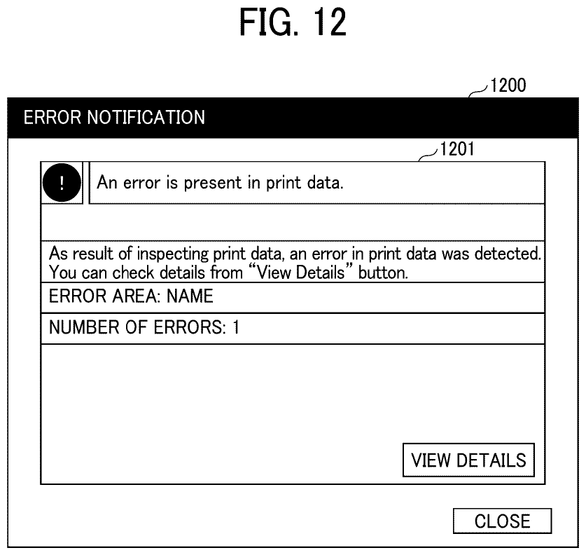

When the processing proceeds from step S504 to step S505, the output unit 405 of the information processing apparatus 100 outputs an error notification. For example, the output unit 405 displays an error notification screen 1200 as illustrated in FIG. 12. As illustrated in FIG. 12, the error notification screen 1200 displays an inspection result 1201 indicating that an error has been detected in the printing data.

On the other hand, when the processing proceeds from step S504 to step S506, the first inspection unit 202 generates the print image data (master data) representing an image when the printing data is printed.

In step S507, the print control unit 203 instructs the printing system 20 to print the printing data. For example, the print control unit 203 transmits, for example, the printing data generated by the generation unit 201 and the print-setting information received by the reception unit 401 to the printing system 20.

In response to this, the RIP processing unit 411 of the printing system 20 converts the printing data received from the information processing apparatus 100 into the raster image printable by a print unit 412, and the print unit 412 prints the converted printing data. The printing system 20 includes a reading unit 413, and the reading unit 413 reads the printed material printed by the print unit 412 and outputs the read image data to the information processing apparatus 100.

In step S508, the image acquisition unit 403 of the information processing apparatus 100 acquires the read image data from the printing system 20.

In step S509, the second inspection unit 204 of the information processing apparatus 100 performs second inspection processing of inspecting the presence of a defect in the printed material on which the printing data is printed.

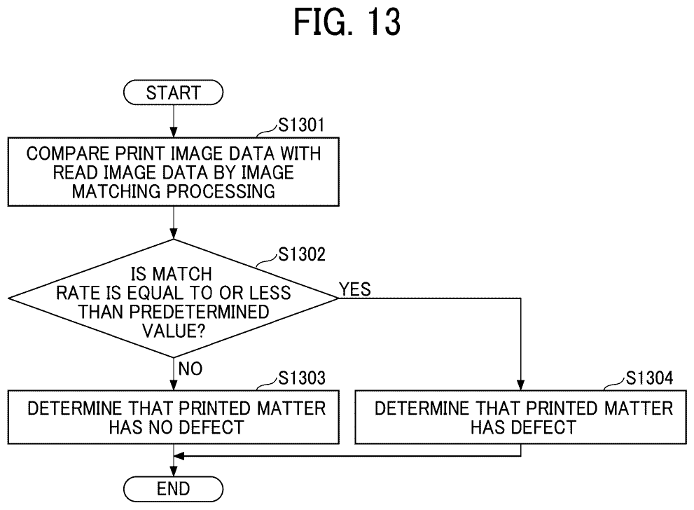

FIG. 13 is a flowchart illustrating an example of the second inspection processing according to the first embodiment. For example, the processing is an example of the second inspection processing in which the second inspection unit 204 inspects the presence of a defect in the printed material in step S509 illustrated in FIG. 5.

In step S1301, the second inspection unit 204 performs comparison processing of comparing the print image data with the read image data by image matching processing. The print image data and the read image data are, for example, black-and-white binary image data. However, this is an example, and the print image data and the read image data may be in various other data formats as long as the image comparison processing is performed.

In step S1302, the second inspection unit 204 determines whether the matching rate compared between the print image data and the read image data in the image matching processing is equal to or less than a predetermined value. When the matching rate is equal to or less than the predetermined value, the second inspection unit 204 moves the processing to step S1304. On the other hand, when the matching rate is not equal to or less than the predetermined value, the second inspection unit 204 moves the processing to step S1303.

When the processing proceeds to step S1303, the second inspection unit 204 determines that the printed material includes no defect. On the other hand, when the processing proceeds to step S1304, the second inspection unit 204 determines that the printed material includes a defect.

Returning to FIG. 5 again, the description of the flowchart of FIG. 5 is further continued. In step S510, when the printed material has a defect, the output unit 405 moves the processing to step S505. On the other hand, when the printed material has no defect, the output unit 405 moves the processing to step S511. In step S505, the output unit 405 displays another error notification screen other than the error notification screen 1200 as illustrated in FIG. 12, indicating that the printed material has a defect.

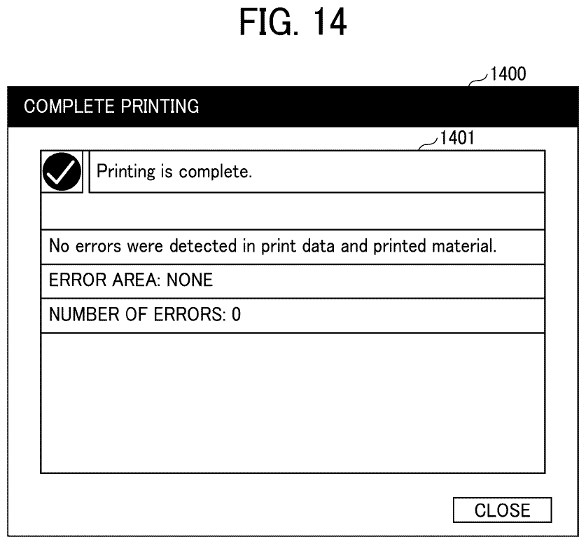

When the processing proceeds to step S511, the output unit 405 outputs a print completion notification indicating that the printing is completed. For example, the output unit 405 displays a print completion screen 1400 as illustrated in FIG. 14. As illustrated in FIG. 14, a printing result 1401 indicating that printing is completed is displayed on the print completion screen 1400.

By the processing illustrated in FIG. 5, the inspection system 1 does not transmit, for example, the printing data and the print-setting information to the printing system 20 when the printing data of the variable printing includes an error, and thus prevents an unnecessary printed material from being generated.

### Second Embodiment

In the first embodiment, the information processing apparatus 100 outputs, for example, the printing data to the printing system 20 when the inspection results of all the variable areas are PASS in the first inspection processing. As another example, the information processing apparatus 100 may output, for example, the printing data to the printing system 20 even when the inspection result of a predetermined variable area is FAIL in the first inspection processing.

### Processing by Inspection System

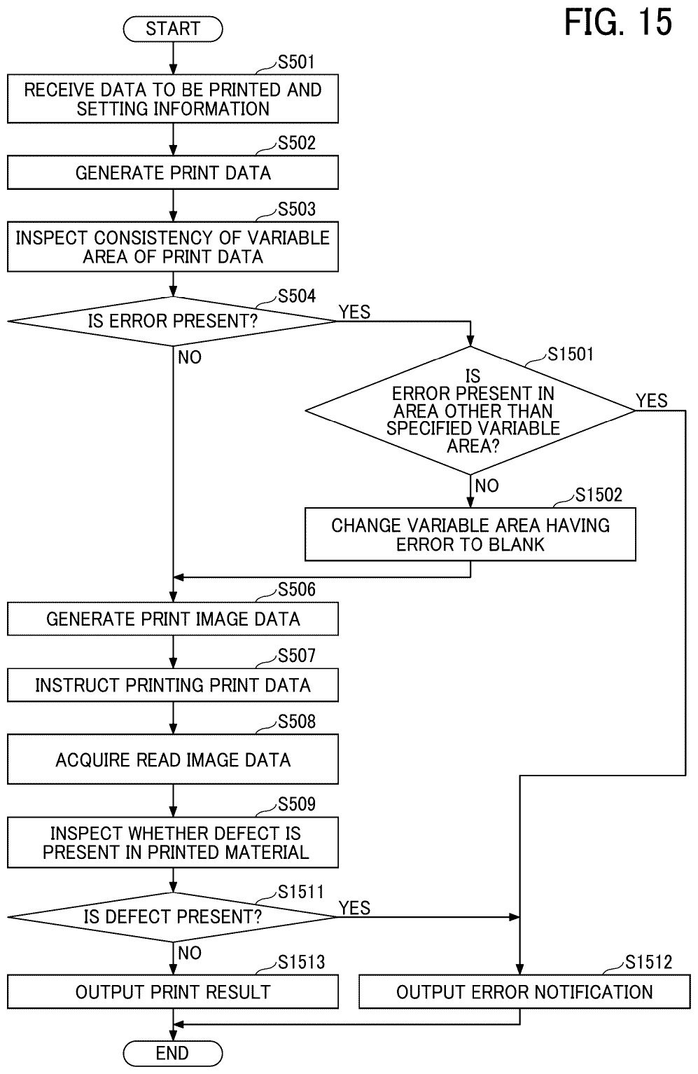

FIG. 15 is a flowchart illustrating an example of processing performed by the inspection system 1 according to a second embodiment. For example, the processing is another example of print inspection processing performed by the information processing apparatus (inspection apparatus) 100 having the functional configuration described with reference to FIG. 4. In the processing illustrated in FIG. 15, the processes of steps S501 to S504 and S506 to S509 are the same as or similar to the processes performed by the inspection system 1 according to the first embodiment described in FIG. 5, and thus the description thereof will be omitted here.

When it is determined that there is an error in the variable area of the printing data in step S504, in step S1501, the print control unit 203 determines whether there is an error in an area other than a predetermined variable area. Here, it is assumed that, as the predetermined variable area, a variable area in which an error of the record information is allowed is set in advance.

When there is an error in an area other than the predetermined variable area, the print control unit 203 moves the processing to step S1512. On the other hand, when there is no error in an area other than the predetermined variable area, the print control unit 203 moves the processing to step S1502.

When the processing proceeds to step S1502, the print control unit 203 modifies the variable area having the error to a blank area using, for example, the printing-data modification unit 402. This is because when the variable area having the error is printed as it is, there is a possibility that erroneous information is printed. The print control unit 203 moves the processing to step S506 to print the modified printing data.

After the processing in steps S506 to S509 is performed, in step S1511, the output unit 405 determines whether there is a defect in the printed material based on the inspection result performed by the second inspection unit 204. When there is a defect in the printed material, the output unit 405 moves the processing to step S1512. On the other hand, when there is no defect in the printed material, the output unit 405 moves the processing to step S1513.

When the processing proceeds to step S1512, the output unit 405 outputs an error notification indicating, for example, whether there is an error in the printing data or in the printed material.

On the other hand, when the processing proceeds to step S1513, the output unit 405 outputs a print completion notification indicating that the printing is completed. In step S1502, when the variable area having an error is modified to a blank area, it is desirable that the print completion notification include information specifying the area modified to the blank area.

As described above, the inspection system 1 instructs the printing system 20 to perform printing a printed material even when the inspection result of a predetermined variable area is FAIL in the first inspection processing.

### Third Embodiment

In the above-described embodiments, the first inspection unit 202 inspects the consistency between the record information of the variable input data and the record information read from the variable area of the printing data. However, this is an example, and the present embodiment may be modified or applied in various ways.

In a third embodiment, an example is described in which the first inspection unit 202 inspects the consistency between data corresponding to the record information of the variable input data and data read from the variable area of the printing data.

In recent years, personalization has been increased in sending direct mails that companies send to their customers. For example, systems are widely used that include an appropriate advertisement content in a direct mail in accordance with the preference of a customer, which is the destination of the direct mail, and send the direct mail to the customer. The inspection system 1 may also inspect personalized data included in the variable area of the printing data.

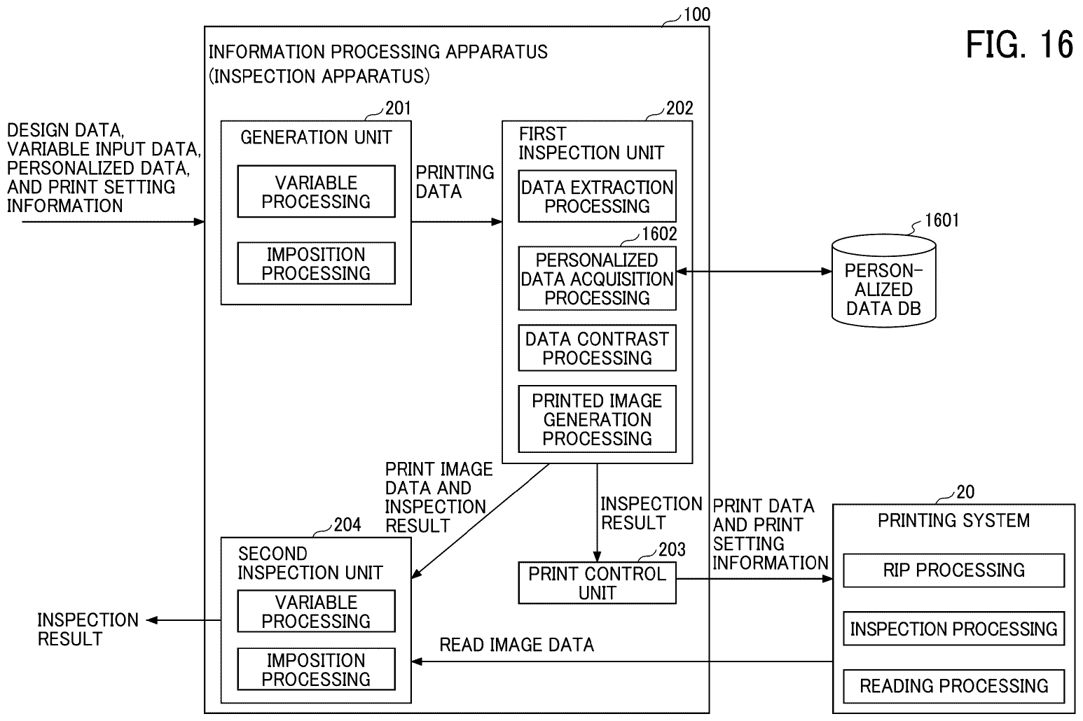

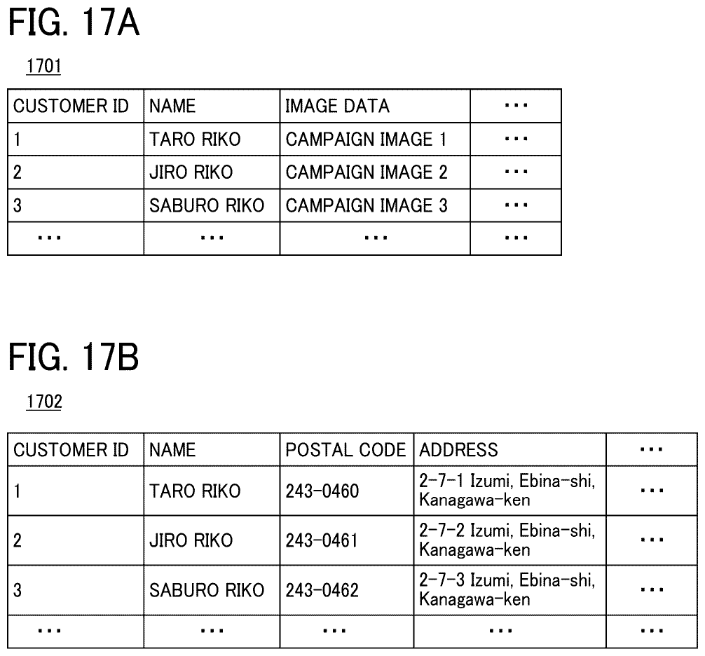

FIG. 16 is a diagram for illustrating an overview of processing according to the third embodiment. In FIG. 16, a personalized data DB 1601 stores, for example, personalized data 1701 that stores image data to be printed on a direct mail for each customer of the destination of the direct mail as illustrated in FIG. 17A.

As illustrated in FIG. 17A, an example of the personalized data 1701 includes information such as “customer ID,” “name,” and “image data” as items. The “customer ID” is identification information for identifying a customer. The “name” is information indicating, for example, the name of the customer. The “image data” is image data to be printed in the variable area of the direct mail to be sent to each customer. As illustrated in FIG. 17A, as an example of image data, a campaign image or link information for specifying a campaign image is stored.

The variable input data 1702 according to the third embodiment includes, for example, “customer ID” as illustrated in FIGS. 17A and 17B. As illustrated in FIG. 17B, an example of the variable input data 1702 includes information such as “customer ID,” “name,” “postal code,” and “address” as items. The customer ID is identification information for identifying a customer, and corresponds to the “customer ID” of the personalized data 1701. The “name” is information indicating, for example, the name of the customer. The “postal code” is information indicating the zip code of the customer. The “address” is information indicating the address of the customer.

As described above, in the third embodiment, the customer (destination) of the variable input data 1702 and the customer of the personalized data 1701 are associated with each other by the “customer ID.”

### Overview of Processing

In FIG. 16, the generation unit 201 of the information processing apparatus 100 generates the printing data based on, for example, the submission data that includes the design data including the variable area, the variable input data 1702, and the personalized data 1701.

The first inspection unit 202 acquires, for example, the personalized data 1701 as illustrated in FIG. 17A from the personalized data DB 1601, and inspects the presence of an error in the data read from the variable area of the printing data. In the third embodiment, the data read from the variable area of the printing data may include not only a character but also an image such as a campaign image.

For example, when the data extracted from the variable area of the printing data is image data, the first inspection unit 202 acquires image data such as a campaign image from the personalized data 1701 based on the customer ID. The first inspection unit 202 compares the image data extracted from the variable area with the image data acquired from the personalized data 1701, to inspect the presence of an error in the data read from the variable area. When there is no error in the data of the variable area of the printing data, the first inspection unit 202 generates print image data obtained by imaging the printing data.

When there is no error in the data read from the variable area of the printing data, the print control unit 203 transmits, for example, the printing data and the print-setting information to the printing system 20 and controls the printing system 20 to start printing the printing data. On the other hand, when there is an error in the data read from the variable area of the printing data, the print control unit 203 controls the printing system 20 to cancel printing the printing data.

The printing system 20 performs the RIP processing and the printing processing on the printing data based on the printing data and the print-setting information received from the information processing apparatus 100, to generate a printed material. Additionally, the printing system 20 performs reading processing on the printed material and transmits the read image data to the information processing apparatus 100.

The second inspection unit 204 performs image comparison processing of comparing the print image data generated by the first inspection unit 202 with the acquired read image data, to perform the second inspection processing of inspecting a defect of a printed material.

By the above-described configuration, the inspection system 1 does not transmit the printing data and the print-setting information to the printing system 20 when the data of the variable area of the printing data includes an error, and thus prevents an unnecessary printed material from being generated.

### Flow of Processing

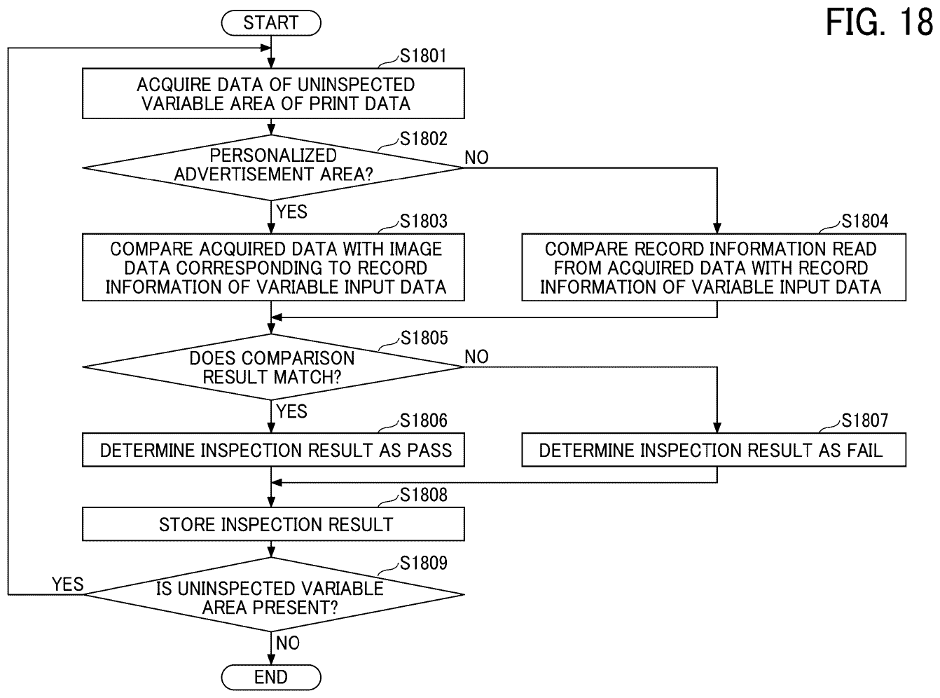

A flow of the first inspection processing according to the third embodiment will be described. FIG. 18 is a flowchart illustrating an example of the first inspection processing according to the third embodiment. The basic processing details are the same as or similar to those of the first inspection processing according to the first embodiment described with reference to FIG. 10, and thus a detailed description of the same or similar to processing as that of the first embodiment will be omitted here.

In step S1801, the first inspection unit 202 acquires data from an uninspected variable area of the printing data.

In step S1802, the first inspection unit 202 determines whether the variable area from which the data is acquired is a personalized advertisement area. When the variable area from which the data is acquired is the personalized advertisement area, the first inspection unit 202 moves the processing to step S1803. On the other hand, when the variable area from which the data is acquired is not the personalized advertisement area, the first inspection unit 202 moves the processing to step S1804.

When the processing proceeds to step S1803, the first inspection unit 202 compares the data acquired from the variable area with the image data corresponding to the record information of the variable input data 1702.

As an example, when the area “area 1” is set as the personalized advertisement area in the area-data association table 730 of the UI screen 700 as illustrated in FIG. 7, the “data” is set as the “customer ID” by, for example, a pull-down menu. In this case, when the record information of the variable input data 1702 is the customer ID “1” in step S1803, the “campaign image 1” corresponding to the customer ID “1” in the personalized data 1701 is the image data corresponding to the record information.

On the other hand, when the processing proceeds to step S1804, the first inspection unit 202 compares the record information read from the acquired data with the record information of the variable input data.

In step S1805, the first inspection unit 202 determines whether the comparison result in step S1803 or step S1804 matches. When the comparison result matches, the first inspection unit 202 moves the processing to step S1806. On the other hand, when the comparison result does not match, the first inspection unit 202 moves the processing to step S1807.

When the processing proceeds to step S1806, the first inspection unit 202 determines that the inspection result of the variable area is “PASS” (there is no problem). On the other hand, when the processing proceeds to step S1807, the first inspection unit 202 determines that the inspection result of the variable area is “FAIL” (there is a problem). In step S1808, the first inspection unit 202 stores the inspection result of the variable area in, for example, the storage unit 406.

In step S1809, the first inspection unit 202 determines whether an uninspected variable area is present. When an uninspected variable area is present, the first inspection unit 202 performs the processing in step S1801 and subsequent steps again. On the other hand, when no uninspected variable area is present, the first inspection unit 202 ends the processing illustrated in FIG. 18.

By the processing illustrated in FIG. 18, the inspection system 1 according to the third embodiment also inspects an error of the image data such as a personalized advertisement included in the printing data of the variable printing before printing.

As described above, according to one or more embodiments of the present disclosure, the inspection system 1 is provided that prevents an unnecessary printed material from being generated is provided when the printing data of the variable printing includes an error.

Each function of each embodiment described above may be implemented by one or more processing circuits or circuitry. The term “processing circuits or circuitry” in the present specification includes a processor programmed to perform each function by software, such as a processor implemented by using an electronic circuit. The term “processing circuits or circuitry” further includes an application specific integrated circuit (ASIC), a digital signal processor (DSP), or a field programmable gate array (FPGA), designed to perform each described-above function. The term “processing circuits or circuitry” further includes a device such as a conventional circuit module.

The functional configuration of the inspection system 1 illustrated in FIG. 4 is an example. For example, in FIG. 4, the functional units of the functional configuration of the information processing apparatus 100 may be distributed among a plurality of apparatuses. At least a part of the functional units of the functional configuration of the information processing apparatus 100 may be implemented by, for example, a program executed by a virtual machine on a cloud.

The present specification includes an inspection system, an inspection apparatus, an inspection method, and a program described in the following aspects.

### Aspect 1

An inspection system includes a generation unit, a first inspection unit, and a print control unit. The generation unit generates printing data from design data including a variable area and record information of variable input data. The first inspection unit inspects whether data read from the variable area of the printing data includes an error, based on the record information of the variable input data. The print control unit controls printing of the printing data in accordance with a result of inspection performed by the first inspection unit.

### Aspect 2

The inspection system according to Aspect 1 further includes a second inspection unit to inspect whether a printed material on which the printing data is printed includes a defect.

### Aspect 3

In the inspection system according to Aspect 2, the second inspection unit compares print image data of the printing data with read image data obtained by reading of the printed material to inspect whether the printed material includes a defect.

### Aspect 4

In the inspection system according to any one of Aspects 1 to 3, when the data read from the variable area of the printing data includes no error, the print control unit controls to start the printing of the printing data.

### Aspect 5

In the inspection system according to any one of Aspects 1 to 4, when the data read from the variable area of the printing data includes no error, the printing control unit controls to cancel the printing of the printing data.

### Aspect 6

In the inspection system according to any one of Aspects 1 to 4, when the data read from the variable area of the printing data includes an error, the print control unit modifies a portion of the error in the variable area of the printing data, and controls to start printing of the modified printing data.

### Aspect 7

In the inspection system according to any one of Aspects 1 to 6, the first inspection unit compares character codes to inspect whether the data read from the variable area of the printing data includes an error.

### Aspect 8

An inspection apparatus includes a generation unit, a first inspection unit, and a print control unit. The generation unit generates printing data from design data including a variable area and record information of variable input data. The first inspection unit inspects whether data read from the variable area of the printing data includes an error, based on the record information of the variable input data. The print control unit controls printing of the printing data in accordance with the result of the inspection performed by the first inspection unit.

### Aspect 9

An inspection method performed by one or more computers includes generating printing data from design data including a variable area and record information of variable input data. The inspection method further includes inspecting whether data read from the variable area of the printing data includes an error, based on the record information of the variable input data. The inspection method further includes controlling printing of the printing data in accordance with a result of the inspecting.

### Aspect 10

A program which, when executed by one or more computers, causes the one or more computers to perform the inspection method according to Aspect 9.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An inspection apparatus comprising:
circuitry configured to:
generate printing data from design data including a variable area and record information of variable input data;
inspect whether data read from the variable area of the printing data includes an error, based on the record information of the variable input data; and
control printing of the printing data in accordance with a result of inspecting the error.

2. The inspection apparatus according to claim 1,
wherein the circuitry inspects whether a printed material on which the printing data is printed includes a defect.

3. The inspection apparatus according to claim 2,
wherein the circuitry compares print image data of the printing data with read image data obtained by reading of the printed material, to inspect whether the printed material includes a defect.

4. The inspection apparatus according to claim 1,
wherein, when the data read from the variable area of the printing data includes no error, the circuitry controls to start the printing of the printing data.

5. The inspection apparatus according to claim 1,
wherein, when the data read from the variable area of the printing data includes an error, the circuitry controls not to start the printing of the printing data.

6. The inspection apparatus according to claim 1,
wherein, when the data read from the variable area of the printing data includes an error, the circuitry modifies a portion of the error in the variable area of the printing data, and controls to start printing the printing data modified.

7. The inspection apparatus according to claim 1,
wherein the circuitry compares character code of the record information acquired from the variable area with character code of the record information of the variable input image to inspect whether the data read from the variable area of the printing data includes an error.

8. An inspection system comprising:
the inspection apparatus according to claim 1; and
a printer to perform printing of the printing data.

9. An inspection method performed by one or more computers, the method comprising:
generating printing data from design data including a variable area and record information of variable input data;
inspecting whether data read from the variable area of the printing data includes an error, based on the record information of the variable input data; and
controlling printing of the printing data in accordance with a result of inspecting the error.

10. A non-transitory recording medium storing a plurality of instructions which, when executed by one or more processors, causes the one or more processors to perform an inspection method, the inspection method comprising:
generating printing data from design data including a variable area and record information of variable input data;
inspecting whether data read from the variable area of the printing data includes an error, based on the record information of the variable input data; and
controlling printing of the printing data in accordance with a result of inspecting the error.
